(19) United States
(12) Patent Application Publication
(10) Pub. No.: US 2025/0216829 A1
(43) Pub. Date: Jul. 3, 2025

(54) CONTROL CHIP, STORAGE CIRCUIT, AND PROTECTION METHOD

(71) Applicant: Nuvoton Technology Corporation, Hsinchu Science Park (TW)

(72) Inventors: Chun-Chi CHEN, Tainan City (TW); Zong-Min LIN, Kaohsiung City (TW)

(21) Appl. No.: 18/984,250

(22) Filed: Dec. 17, 2024

(30) Foreign Application Priority Data
Dec. 29, 2023 (TW) 112151468

(51) Int. Cl. G05B 19/042; G06V 10/82; H10B 20/00

(52) U.S. Cl. CPC G05B 19/0423; G06V 10/82; H10B 20/65

(57) ABSTRACT

A control chip including a first processing circuit, a second processing circuit, and a storage circuit. The first processing circuit provides a learning procedure and learning data. The second processing circuit is configured to execute the learning procedure. The storage circuit stores the learning procedure and the learning data. In response to an access request pointing to the learning procedure, the storage circuit determines whether the access request is a correct access request. In response to the access request being a correct access request, the storage circuit provides the learning procedure to the second processing circuit. In response to the access request pointing to the learning data, the storage circuit determines whether the access request is provided from the second processing circuit. In response to the access request being provided from the second processing circuit, the storage circuit provides the learning data to the second processing circuit.

### CROSS REFERENCE TO RELATED APPLICATIONS

This application claims priority of Taiwan Patent Application No. 112151468, filed on Dec. 29, 2023, the entirety of which is incorporated by reference herein.

### BACKGROUND OF THE INVENTION

### Field of the Invention

The present invention relates to a control chip, and, in particular, to a control chip that comprises a storage circuit.

### Description of the Related Art

Artificial neural network models use technology in the field of artificial intelligence. A predefined network architecture and a large number of parameters, such as weight and bias, are used to implement very complex applications, such as facial recognition. However, the artificial neural network model can easily be stolen and used by unauthorized users.

### BRIEF SUMMARY OF THE INVENTION

In accordance with an embodiment of the disclosure, a control chip comprises a first processing circuit, a second processing circuit, and a storage circuit. The first processing circuit provides a learning procedure and learning data. The second processing circuit is configured to execute the learning procedure. The storage circuit stores the learning procedure and the learning data. In response to an access request pointing to the learning procedure, the storage circuit determines whether the access request is a correct access request. In response to the access request being a correct access request, the storage circuit provides the learning procedure to the second processing circuit. In response to the access request pointing to the learning data, the storage circuit determines whether the access request is provided from the second processing circuit and decodes identification information to generate a decoded result. In response to the access request being provided from the second processing circuit and the decoded result corresponding to the second processing circuit, the storage circuit provides the learning data to the second processing circuit.

In accordance with another embodiment of the disclosure, a storage circuit comprises a memory and a control circuit. The memory comprises a first region and a second region. The first region stores a learning procedure. The second region stores learning data. The control circuit determines whether to access the first or second region according to an access request. In response to the access request pointing to the first region, the control circuit determines whether the access request is a correct access request. In response to the access request being the correct access request, the control circuit outputs the learning procedure stored in the first region. In response to the access request pointing to the second region, the control circuit determines whether the access request is provided by a specific circuit and decodes identification information to generate a decoded result. In response to the access request being provided by the specific circuit, the control circuit outputs the learning data stored in the second region to the specific circuit.

A protection method for a control chip is provided. An exemplary embodiment of a protection method for a control chip is described in the following paragraph. A learning procedure and learning data are stored to a memory. In response to an access request pointing to the learning procedure, a determination is made as to whether the access request is provided from a specific circuit and a determination is made as to whether the access request is an instruction fetch request. In response to the access request being provided from the specific circuit and the access request is an instruction fetch request, the learning procedure is output to the specific circuit. In response to the access request pointing to the learning data, a determination is made as to whether the access request is provided from the specific circuit and identification information is decoded to generate a decoded result. In response to the access request being provided from the specific circuit and the decoded result corresponding to the specific circuit, the learning data is output to the specific circuit.

Protection methods may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a control chip and a storage circuit for practicing the disclosed method.

### BRIEF DESCRIPTION OF THE DRAWINGS

The present invention can be more fully understood by reading the subsequent detailed description and examples with references made to the accompanying drawings, wherein:

FIG. 1A is a schematic diagram of an exemplary embodiment of a control chip according to various aspects of the present disclosure.

FIG. 1B is a schematic diagram of another exemplary embodiment of the control chip according to various aspects of the present disclosure.

FIG. 2 is a schematic diagram of an exemplary embodiment of the storage circuit of FIG. 1A according to various aspects of the present disclosure.

FIG. 3 is a schematic diagram of an exemplary embodiment of the storage circuit of FIG. 1B according to various aspects of the present disclosure.

FIG. 4 is an operating schematic diagram of an exemplary embodiment of the storage circuit according to various aspects of the present disclosure.

FIG. 5 is a flowchart of an exemplary embodiment of a protection method in accordance with an embodiment of the present disclosure.

FIG. 6 is a flowchart of another exemplary embodiment of the protection method in accordance with an embodiment of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

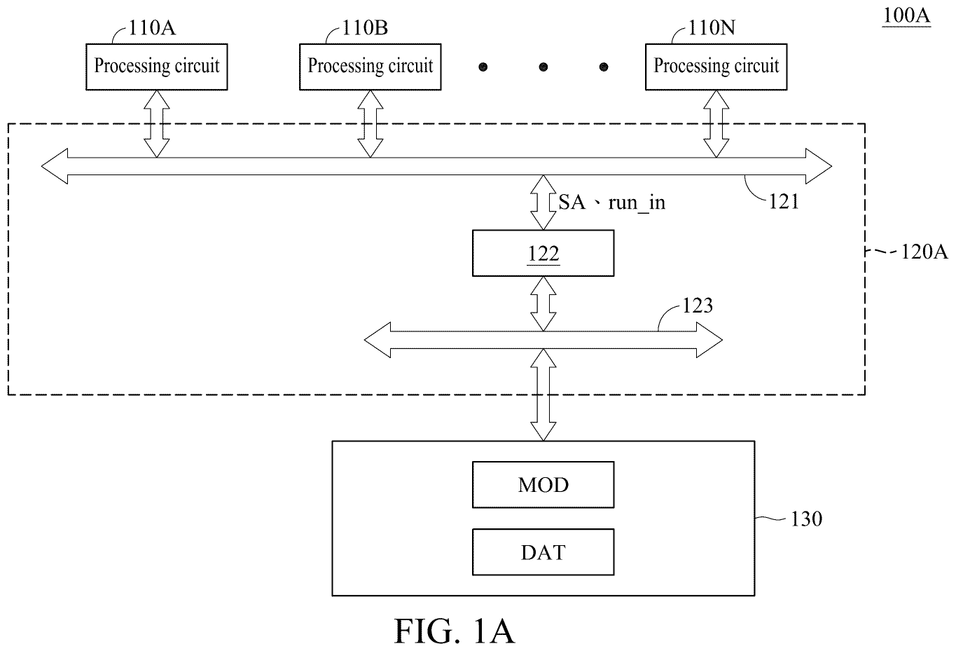

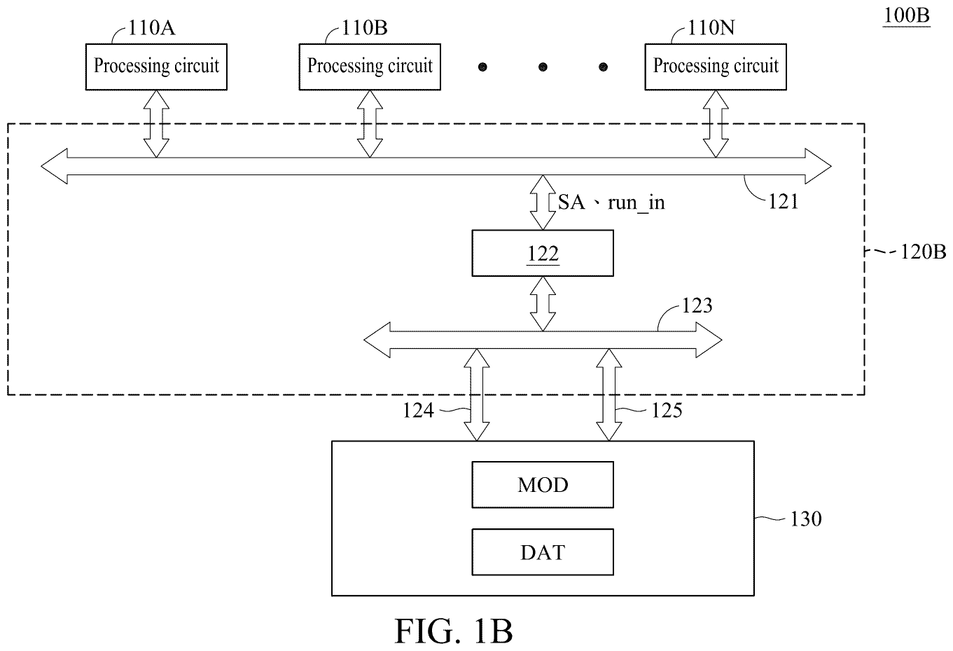

FIG. 1A is a schematic diagram of an exemplary embodiment of a control chip according to various aspects of the present disclosure. As shown in FIG. 1A, the control chip 100A comprises processing circuits 110A˜110N, a bus circuit 120A, and a storage circuit 130. Any of the processing circuits 110A˜110N writes a learning procedure MOD and learning data DAT to the storage circuit 130 via the bus circuit 120A. Anyone of the processing circuits 110A˜110N stores a machine learning model according to the learning procedure MOD and the learning data DAT. The number of processing circuits is not limited in the present disclosure. In other embodiments, the control chip 100A comprises more processing circuits or fewer processing circuits.

The kind of processing circuit is not limited in the present disclosure. In one embodiment, one of the processing circuits 110A˜110N is a central processing unit (CPU). In this case, the CPU may provide the learning procedure MOD and the learning data DAT. In another embodiment, another of the processing circuits 110A˜110N is a neural network operating accelerator or a neural processing unit (NPU). The NPU performs a machine learning inference operation according to the learning procedure MOD and the learning data DAT stored in the storage circuit 130.

The bus circuit 120A is coupled between the processing circuits 110A˜110N and the storage circuit 130 to transmit signals and data. The structure of the bus circuit 120A is not limited in the present disclosure. In one embodiment, the bus circuit 120A comprises an advanced extensible interface (AXI) bus 121, a conversion circuit 122, and an advanced high performance bus (AHB) 123.

The AXI bus 121 is coupled to the processing circuits 110A˜110N and the conversion circuit 122. The conversion circuit 122 is configured to perform a conversion operation between an AXI transmission protocol and an AHB transmission protocol. For example, the conversion circuit 122 may convert the signals of the AXI bus 121 from the AXI transmission protocol to the AHB transmission protocol and then provide the converted result to the AHB 123. In another embodiment, the conversion circuit 122 may convert the signals of the AHB 123 from the AHB transmission protocol to the AXI transmission protocol and then provide the converted result to the AXI but 121. The AHB 123 is coupled between the conversion circuit 122 and the storage circuit 130.

The storage circuit 130 receives the learning procedure MOD and the learning data DAT via the bus circuit 120A and stores the learning procedure MOD and the learning data DAT. When an access request SA points to the learning procedure MOD, the storage circuit 130 determines whether the access request SA is a correct access request. When the access request SA is a correct access request, the storage circuit 130 uses the bus circuit 120A to output the learning procedure MOD to a processing circuit which sends the access request SA.

The present disclosure does not limit how the storage circuit 130 determines whether the access request SA is a correct access request. In one embodiment, the storage circuit 130 determines whether the access request SA is provided from a specific circuit. For brevity, assume that the processing circuit 100B is a specific circuit. When the access request SA is provided from the processing circuit 100B, it is determined that the access request SA is a correct access request. However, when the access request SA is not provided from the processing circuit 100B, it is determined that the access request SA is not a correct access request. Therefore, the storage circuit 130 does not provide the learning procedure MOD to the processing circuit 100B. In another embodiment, the storage circuit 130 further determines whether the access request SA is an instruction fetch request. When the access request SA is provided by the processing circuit 100B and the access request SA is the instruction fetch request, it is determined that the access request SA is a correct access request. However, when the access request SA is not provided by the processing circuit 100B or the access request SA does not the instruction fetch request, it is determined that the access request SA is an incorrect access request. Therefore, the storage circuit 130 does not provide the learning procedure MOD to the processing circuit 100B.

The present disclosure does not limit how the storage circuit 130 determines whether the access request SA is provided by the processing circuit 110B. In some embodiments, the storage circuit 130 decodes the access request SA to generate a decoded result and then determines whether the access request SA is provided by the processing circuit 100B according to the decoded result. In another embodiment, the storage circuit 130 determines whether the access request SA is an instruction fetch request according to the decoded result.

After receiving the learning procedure MOD, the processing circuit 100B executes the learning procedure MOD to perform a machine learning inference operation. When the processing circuit 100B starts performing the machine learning inference operation, if the processing circuit 100B needs the learning data DAT, the processing circuit 100B re-sends the access request SA. The storage circuit 130 determines whether to provide the learning data DAT according to the access request SA. In one embodiment, the storage circuit 130 determines whether the access request SA is provided by a specific circuit. Assume that the processing circuit 100B is the specific circuit. In this case, when the access request SA is provided by the processing circuit 100B, the storage circuit 130 provides the learning data DAT to the processing circuit 100B via the bus circuit 120A. However, when the access request SA is provided by the processing circuit 100N, the storage circuit 130 rejects the access request SA. At this time, the storage circuit 130 does not provide the access request SA.

The present disclosure does not limit how the storage circuit 130 determines whether the access request SA is provided by a specific circuit. In one embodiment, when the processing circuit 110B executes the learning procedure MOD, the processing circuit 110B enables the identification information run_in. Therefore, when the access request SA points to the learning data DAT, since the identification information run_in is enabled, the storage circuit 130 provides the learning data DAT. However, when the identification information run_in is not enabled, even if the access request SA is provided by the processing circuit 110B, the storage circuit 130 does not provide the learning data DAT. In another embodiment, the identification information run_in is predetermined information. In this case, the identification information run_in may be provided by one of the processing circuits 110A˜110N. The storage circuit 130 decodes the identification information run_in to generate a decoded result. Assume that the decoded result corresponds to the processing circuit 110B. In this case, when the access request SA is provided by the processing circuit 110B, the storage circuit 130 outputs the learning data DAT. When the access request SA is provided by the processing circuit 110A, since the decoded result does not correspond to the processing circuit 110A, the storage circuit 130 rejects the access request SA provided by the processing circuit 110A and does not provide the learning data DAT to the processing circuit 110A.

The source of the learning procedure MOD and the source of the learning data DAT are not limited in the present disclosure. In one embodiment, the learning procedure MOD and the learning data DAT are provided by one of the processing circuits 110A˜110N. Taking the processing circuit 110A as an example, the processing circuit 110A writes the learning procedure MOD and the learning data DAT to the storage circuit 130 via the bus circuit 120A. In some embodiment, the access request SA and the identification information run_in may be provided by the same processing circuit or different processing circuits.

FIG. 1B is a schematic diagram of another exemplary embodiment of the control chip according to various aspects of the present disclosure. As shown in FIG. 1B, the control chip 100B comprises processing circuits 110A˜110N, a bus circuit 120B, and a storage circuit 130. The bus circuit 120B is similar to the bus circuit 120A with the exception that the bus circuit 120B further comprises buses 124 and 125.

The storage circuit 130 receives the access request SA and the identification information run_in via the bus 124 and outputs the learning procedure MOD and the learning data DAT to the AHB 123 via the bus 124.

The storage circuit 130 receives a write request (not shown) via the bus 125. The storage circuit 130 stores the learning procedure MOD and the learning data DAT transmitted by the bus 125 according to the write request. In another embodiment, the storage circuit 130 receives an elimination request via the bus 125. The storage circuit 130 erases the learning procedure MOD and the learning data DAT according to the elimination request.

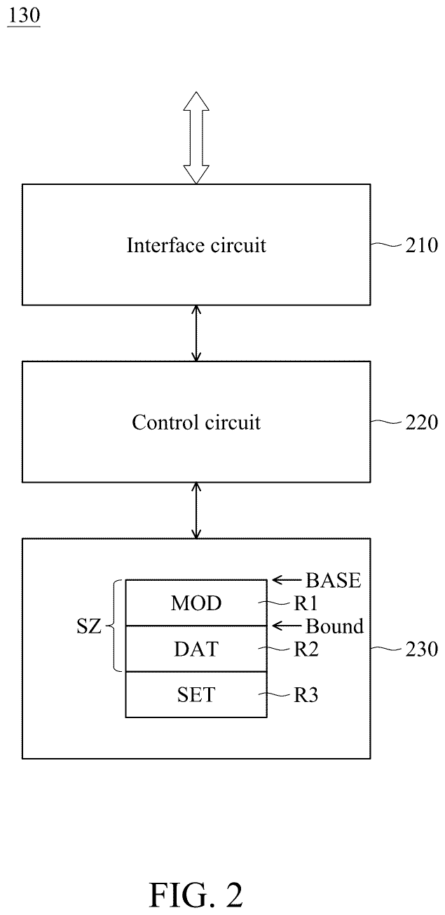

FIG. 2 is a schematic diagram of an exemplary embodiment of the storage circuit of FIG. 1A according to various aspects of the present disclosure. The storage circuit 130 comprises an interface circuit 210, a control circuit 220, and a memory 230. The interface circuit 210 is coupled to the AHB 123 to receive the learning procedure MOD and the learning data DAT. The control circuit 220 writes the learning procedure MOD and the learning data DAT into the memory 230.

In other embodiments, the interface circuit 210 further receive setting data SET. The setting data SET may be provided by one of the processing circuits 110A˜110N. The control circuit 220 defines the regions R1 and R2 in the storage space of the memory 230 according to the address information BASE, the size information SZ and the boundary information Bound of the setting data SET. In this case, the address information BASE indicates the start address of the region R1. The size information SZ indicates the size of the region R1 and the size of the region R2. The boundary information Bound indicates the end address of the region R1 or the start address of the region R2.

In this embodiment, the regions R1 and R2 are continuous storage spaces, but the disclosure is not limited thereto. In other embodiments, the regions R1 and R2 are discontinuous storage spaces. For example, there is other storage space between the regions R1 and R2 to store other data besides the learning procedure MOD and the learning data DAT.

After defining the regions R1 and R2, when the control circuit 220 receives the learning procedure MOD and the learning data DAT, the control circuit 220 writes the learning procedure MOD into the region R1 and writes the learning data DAT into the region R2. In some embodiments, the control circuit 220 stores the setting data SET in the region R3. In one embodiment, the memory 230 is a read only memory (ROM).

In other embodiments, the interface circuit 210 further receives the access request SA. The control circuit 220 determines whether to access the region R1 or R2 according to the access request SA. For example, when the access request SA points to the region R1, the control circuit 220 determines whether the access request SA is a correct access request. In one embodiment, the control circuit 220 determines whether the access request SA is provided from a specific circuit. When the access request SA is provided from a specific circuit (e.g., the processing circuit 110B), it is determined that the access request SA is a correct access request. Therefore, the control circuit 220 accesses the learning procedure MOD from the region R1 and outputs the learning procedure MOD via the interface circuit 210. However, when the access request SA is not provided from a specific circuit, the control circuit 220 does not access the region R1. In this case, the control circuit 220 rejects providing the learning procedure MOD.

In another embodiment, when the access request SA points to the region R1 and the access request SA is provided by a specific circuit, the control circuit 220 determines whether the access request SA is an instruction fetch request. When the access request SA is an instruction fetch request, this indicates that the access request SA is a correct access request. Therefore, the control circuit 220 provides the learning procedure MOD stored in the region R1 to the specific circuit. However, when the access request SA is not provided by a specific circuit or the access request SA is not an instruction fetch request, the control circuit 220 does not access the region R1.

In some embodiments, when the access request SA points to the region R2, the control circuit 220 determines whether the access request SA is provided by a specific circuit and decodes the identification information run_in to generate a decoded result. When the access request SA is provided by a specific circuit and the decoded result corresponds to the specific circuit, the control circuit 220 outputs the learning data DAT stored in the region R2 to the specific circuit. However, when be access request SA is not provided by a specific circuit or the decoded result does not correspond to the specific circuit, the control circuit 220 does not access the region R2.

In one embodiment, the identification information run_in is provided by the specific circuit. For brevity, assume that the processing circuit 110B is served as a specific circuit. In this case, when the processing circuit 110B executes the learning procedure MOD, the processing circuit 110B enables the identification information run_in. In this case, when the identification information run_in is enabled and the access request SA points to the region R2, the control circuit 220 determines whether the access request SA is sent by the processing circuit 110B. If the access request SA is sent by the processing circuit 110B, the control circuit 220 provides the learning data DAT to the processing circuit 110B. When the processing circuit 110B does not send the access request SA, even if the identification information run_in is enabled, the control circuit 220 rejects the access request SA and does not access the region R2.

In another embodiment, the identification information run_in is a predetermined value and may be provided by one of the processing circuits 110A˜110N. In this case, the control circuit 220 decodes the identification information run_in to generate a decoded result. The control circuit 220 utilizes the decoded result to determine which of the processing circuits 110A˜110N is a specific circuit. Assume that the decoded result corresponds to the processing circuit 110B. In this case, when the access request SA points to the region R2 and the access request SA is send by the processing circuit 110B, since the decoded result corresponds to the processing circuit 110B, the control circuit 220 provides the learning data DAT to the processing circuit 110B. If the processing circuit 110B does not send the access request SA, the control circuit 220 does not read the region R2.

In other embodiment, when the control circuit 220 receives an elimination request, the control circuit 220 erases the learning procedure MOD from the region R1 and erases the learning data DAT from the region R2. After the learning procedure MOD stored in the region R1 and the learning data DAT stored in the region R2 have been erased, the control circuit 220 erases the setting data SET from the region R3. Since the control circuit 220 erases the setting data SET last, it can avoid interruption in the process of erasing the learning procedure MOD stored in the region R1 and the learning data DAT stored in the region R2, resulting in the leak of the learning procedure MOD and the learning data DAT.

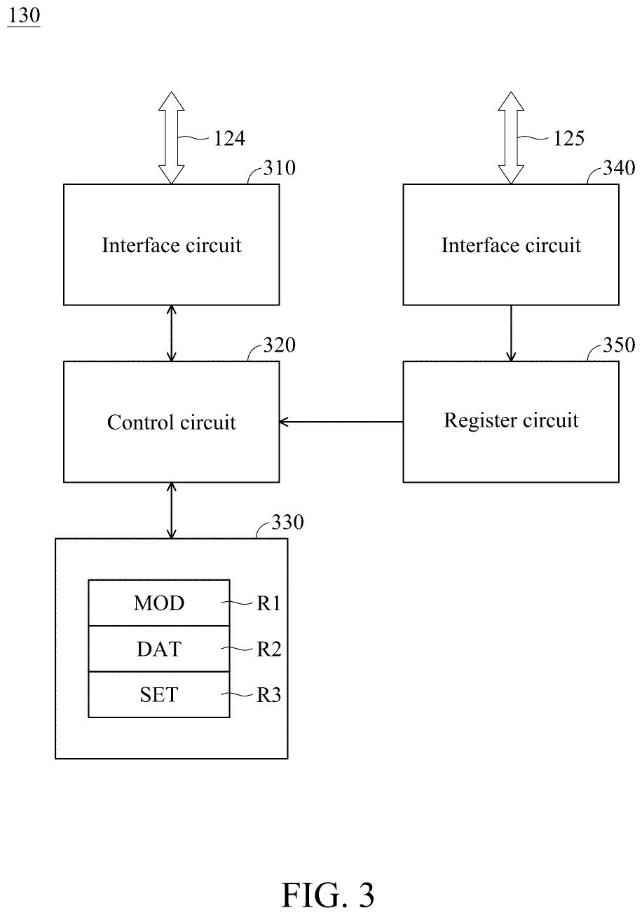

FIG. 3 is a schematic diagram of an exemplary embodiment of the storage circuit of FIG. 1B according to various aspects of the present disclosure. The storage circuit 130 comprises interface circuits 310 and 340, a control circuit 320, a memory 330, and a register circuit 350. The interface circuit 310 is coupled between the bus 124 and the control circuit 320 to receive the access request SA and the identification information run_in and to provide the access request SA and the identification information run_in to the control circuit 320.

The control circuit 320 accesses the regions R1 and R2 according to the access request SA and the identification information run_in. Since the characteristics of the control circuit 320 and the memory 330 shown in FIG. 3 are similar to the characteristics of the control circuit 220 and the memory 230 shown in FIG. 2, the related description is omitted here.

The interface circuit 340 is coupled between the bus 125 and the register circuit 350 to receive a specific request, such as a write request or an elimination request. In one embodiment, when the interface circuit 340 receives a write request, the interface circuit 340 may set a write register (not shown) of the register circuit 350 and stores the learning procedure MOD and the learning data DAT into the register circuit 350. The control circuit 320 moves the learning procedure MOD and the learning data DAT from the register 350 to the memory 330 according to the value of the write register. In another embodiment, the interface circuit 340 also stores the setting data SET into the register circuit 350.

In other embodiments, when receiving an elimination request, the interface circuit 340 sets an elimination register (not shown) of the register circuit 350. The control circuit 320 erases the learning procedure MOD from the region R1 and the learning data DAT from the register R2 according to the value of the elimination register. After erasing the regions R1 and R2, the control circuit 320 erases the region R3.

In some embodiments, the memory 330 may be divided into a secure world and a non-secure world. The data in the secure world is used by at least one processing circuit which has high security level, and the data in the non-secure world is used by all processing circuits. In one embodiment, one of the regions R1˜R3 is located in the secure world, and another of the regions R1˜R3 is located in the non-secure world. In some embodiments, all of the regions R1˜R3 are located in the secure world or in the non-secure world.

When the regions R1˜R3 are located in the secure world, the control circuit 320 only accepts the elimination requests from the processing circuits with a high security level, and rejects the elimination request from processing circuits with a low security level. For example, if the processing circuit 110A shown in FIG. 1B has a high security level and the processing circuit 110B has a low security level, the control circuit 320 only accepts the elimination request from the processing circuit 110A and rejects the elimination request from the processing circuit 110B.

However, even if the processing circuit 110A has a high security level, as long as the processing circuit 110A is not set to a specific circuit, the processing circuit 110A cannot require the control circuit 320 to provide the learning procedure MOD and the learning data DAT. In this case, the control circuit 320 decodes the identification information run_in to determine which processing circuit is set as a specific circuit. The control circuit 320 provides the learning procedure MOD and the learning data DAT to the specific circuit.

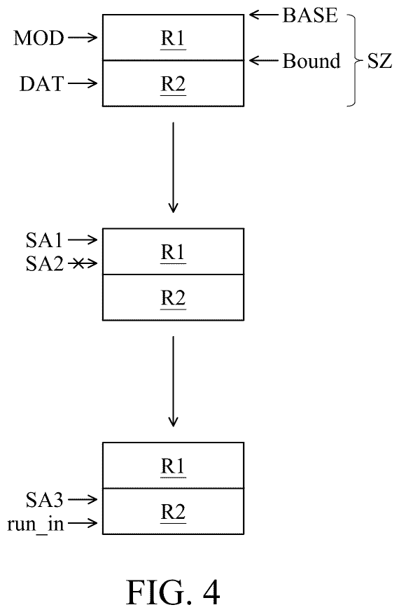

FIG. 4 is an operating schematic diagram of an exemplary embodiment of the storage circuit according to various aspects of the present disclosure. Taking FIG. 3 as an example, the control circuit 320 defines the regions R1 and R2 in the storage space of the memory 230 according to the address information BASE, the size information SZ and the boundary information Bound of the setting data SET. In this case, the address information BASE corresponds to the start address of the region R1, the size information SZ corresponds to the total storage capacity of the regions R1 and R2, and the boundary information Bound corresponds to the boundary between regions R1 and R2.

After defining the regions R1 and R2, the control circuit 320 writes the learning procedure MOD into the region R1 and writes the learning data DAT into the region R2. In some embodiments, one of the processing circuits 110A˜110N trains and generates a facial recognition model. The facial recognition model is provided to the storage circuit 130. In another embodiment, one of the processing circuits 110A˜110N provides the face data to be recognized as the learning data DAT to the storage circuit 130. The processing circuit that provides the learning procedure MOD may be the same as or different from the processing circuit that provides the learning data DAT.

Next, the control circuit 320 determines whether the access request SA1 is a correct access request. In one embodiment, when the access request SA1 is provided by a specific circuit (e.g., the processing circuit 110B), the control circuit 320 reads the learning procedure MOD stored in the region R1 according to the access request SA1. However, when an access request SA2 is not provided by the specific circuit, the control circuit 320 rejects the access request SA2.

After receiving the learning procedure MOD, the specific circuit executes the learning procedure MOD and enables an identification information run_in. At this time, when the control circuit 320 receives an access request SA3 from the specific circuit, since the identification information run_in is enabled, the control circuit 320 reads the learning data DAT stored in the region R2. In other embodiment, the identification information run_in may be provided by other circuit. In this case, the control circuit 320 decodes the identification information run_in to generate a decoded result. The control circuit 320 determines the identification code of the specific circuit according to the decoded result. Therefore, when the control circuit 320 receives the access request SA3, the control circuit 320 decodes the access request SA3 to determine the identification code of the processing circuit which sends the access request SA3. When the identification code of the processing circuit is the same as the identification code which is pointed by the identification information run_in, the control circuit 320 reads and outputs the learning data DAT stored in the region R2.

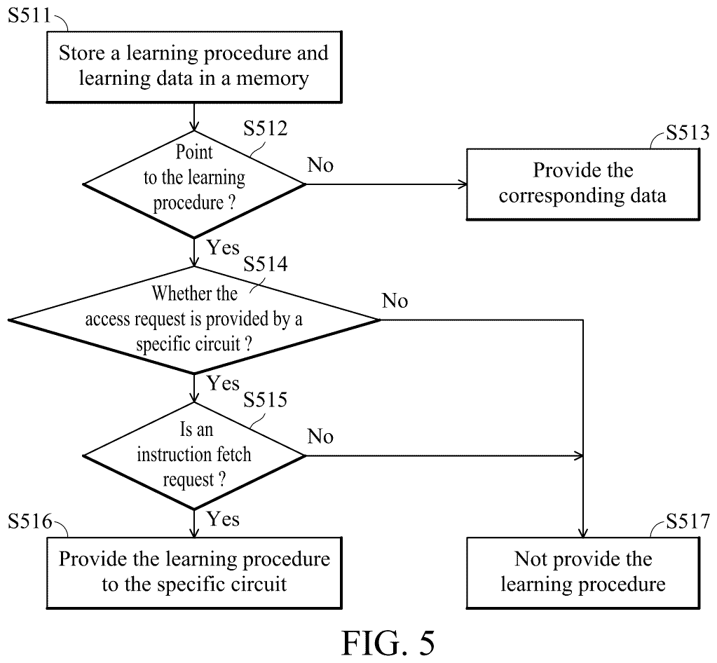

FIG. 5 is a flowchart of an exemplary embodiment of a protection method in accordance with an embodiment of the present disclosure. The protection methods may take the form of a program code. When the program code is loaded into and executed by a machine, the machine thereby becomes a control chip and a storage circuit for practicing the protection methods. First, a learning procedure and learning data are stored in a memory (step S511).

Then, a determination is made as to whether an access request points to the learning procedure (step S512). When the access request does not point to the learning procedure, the corresponding data is provided according to the address pointed to by the access request (step S513). When the access request points to the learning procedure, a determination is made as to whether the access request is provided by a specific circuit (step S514). When the access request is not provided by the specific circuit, the learning procedure does not be provided (step S517). When the access request is provided by the specific circuit, a determination is made as to whether the access request is an instruction fetch request (step S515). When the access request is not an instruction fetch request, the learning procedure does not be provided (step S517). However, when the access request is an instruction fetch request, the learning procedure is provided to the specific circuit (step S516).

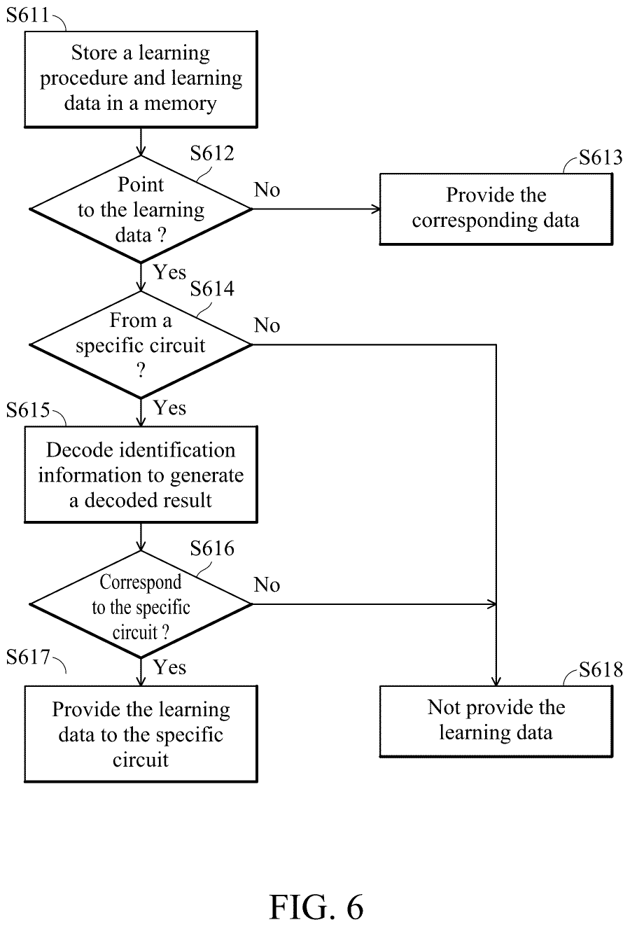

FIG. 6 is a flowchart of another exemplary embodiment of the protection method in accordance with an embodiment of the present disclosure. The protection methods may take the form of a program code. When the program code is loaded into and executed by a machine, the machine thereby becomes a control chip and a storage circuit for practicing the protection methods. First, a learning procedure and learning data are stored in a memory (step S611).

Then, a determination is made as to whether an access request points to the learning data (step S612). When the access request does not point to the learning data, the corresponding data is provided according to the address pointed to by the access request (step S613). When the access request points to the learning data, a determination is made as to whether the access request is provided by a specific circuit (step S614). When the access request is not provided by the specific circuit, the access request is rejected (step S618). When the access request is provided by the specific circuit, the identification information is decoded to generate a decoded result (step S615).

Then, a determination is made as to whether the decoded result corresponds to the specific circuit (step S616). When the decoded result does not correspond to the specific circuit, the access request is rejected (step S618). When the decoded result corresponds to the specific circuit, the learning data is provided to the specific circuit (step S517).

It will be understood that when an element is referred to as being “coupled to” another element, it can be directly coupled to the other element or intervening elements may be present. In contrast, when an element is referred to as be “directly connected to” another element, there are no intervening elements present. Additionally, “enable” shall mean changing the state of a Boolean signal. Boolean signals may be enabled high or with a higher voltage, and Boolean signals may be enabled low or with a lower voltage, at the discretion of the circuit designer. Similarly, “disable” shall mean changing the state of the Boolean signal to a voltage level opposite the enabled state.

Protection methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a control chip and a storage circuit for practicing the methods. The protection methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a control chip and a storage circuit for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control chip comprising:
a first processing circuit providing a learning procedure and learning data;
a second processing circuit configured to execute the learning procedure; and
a storage circuit storing the learning procedure and the learning data,
wherein:
in response to an access request pointing to the learning procedure:
the storage circuit determines whether the access request is a correct access request,
in response to the access request being the correct access request, the storage circuit provides the learning procedure to the second processing circuit,
in response to the access request pointing to the learning data:
the storage circuit determines whether the access request is provided from the second processing circuit and decodes identification information to generate a decoded result,
in response to the access request being provided from the second processing circuit and the decoded result corresponding to the second processing circuit, the storage circuit provides the learning data to the second processing circuit.

2. The control chip as claimed in claim 1, wherein:
in response to the access request pointing to the learning procedure, the storage circuit determines whether the access request is provided from the second processing circuit and whether the access request is an instruction fetch request, and
responsive to determining that the access request is provided from the second processing circuit and the access request is an instruction fetch request, the storage circuit determines that the access request is the correct access request.

3. The control chip as claimed in claim 2, wherein in response to the access request not being provided from the second processing circuit or the access request not being an instruction fetch request, the storage circuit does not provide the learning procedure to the second processing circuit.

4. The control chip as claimed in claim 1, wherein the storage circuit comprises:
a memory comprising:
a first region configured to store the learning procedure; and
a second region configured to store the learning data; and
a control circuit accessing the first or second region according to the access request.

5. The control chip as claimed in claim 4, wherein the storage circuit further comprises:
a third region configured to store setting data,
wherein the control circuit sets a size of the first region and a size of the second region according to the setting data.

6. The control chip as claimed in claim 5, wherein:
the control circuit erases the learning procedure from the first region and the learning data from the second region, and
after the learning procedure stored in the first region and the learning data stored in the second region have been erased, the control circuit erases the setting data from the third region.

7. The control chip as claimed in claim 5, wherein the storage circuit further comprises:
a first interface circuit configured to receive the identification information and the access request and provide the identification information and the access request to the control circuit,
wherein the control circuit determines whether to read the first and second regions according to the access request.

8. The control chip as claimed in claim 7, wherein the storage circuit further comprises:
a second interface circuit configured to receive the learning procedure and the learning data and provide the learning procedure and the learning data to a register circuit,
wherein the control circuit moves the learning procedure which is provisionally stored in the register circuit to the first region and moves the learning data which is provisionally stored in the register circuit to the second region.

9. The control chip as claimed in claim 4, wherein the second processing circuit is a neural network operating accelerator which performs a machine learning inference operation according to the learning procedure and the learning data, and the memory is a read only memory.

10. The control chip as claimed in claim 1, wherein:
in response to the access request pointing to the learning data:
in response to the access request not being provided from the second processing circuit or the access request not being an instruction fetch request, the storage circuit does not provide the learning data to the second processing circuit.

11. A storage circuit comprising:
a memory comprising:
a first region storing a learning procedure; and
a second region storing learning data; and
a control circuit determining whether to access the first or second region according to an access request,
wherein:
in response to the access request pointing to the first region:
the control circuit determines whether the access request is a correct access request,
responsive to determining that the access request is a correct access request, the control circuit outputs the learning procedure stored in the first region,
in response to the access request pointing to the second region:
the control circuit determines whether the access request is provided by a specific circuit,
the control circuit decodes identification information to generate a decoded result, and
responsive to determining that the access request is provided by the specific circuit, the control circuit outputs the learning data stored in the second region to the specific circuit.

12. The storage circuit as claimed in claim 11, wherein in response to the access request pointing to the first region:
the control circuit determines whether the access request is provided by the specific circuit and whether the access request is an instruction fetch request,
responsive to determining that the access request is provided by the specific circuit and the access request is an instruction fetch request, it is determined that the access request is the correct access request, and
responsive to determining that the access request is a correct access request, the control circuit outputs the learning procedure to the specific circuit.

13. The storage circuit as claimed in claim 12, wherein:
in response to the access request pointing to the first region:
responsive to determining that the access request is not provided by the specific circuit or the access request is not an instruction fetch request, the control circuit does not access the first region.

14. The storage circuit as claimed in claim 13, wherein:
in response to the access request pointing to the second region:
responsive to determining that the access request is not provided by the specific circuit or the decoded result does not correspond to the specific circuit, the control circuit does not access the second region.

15. The storage circuit as claimed in claim 11, further comprising:
a first interface circuit configured to receive the identification information and the access request and provide the identification information and the access request to the control circuit.

16. The storage circuit as claimed in claim 15, further comprising:
a register circuit; and
a second interface circuit configured to receive the learning procedure and the learning data and provide the learning procedure and the learning data to the register circuit,
wherein the control circuit moves the learning procedure which is provisionally stored in the register circuit to the first region and moves the learning data which is provisionally stored in the register circuit to the second region.

17. The storage circuit as claimed in claim 16, wherein the memory is a read only memory.

18. The storage circuit as claimed in claim 16, wherein the memory further comprises:
a third region configured to store setting data,
wherein the control circuit sets a size of the first region and a size of the second region according to the setting data.

19. The storage circuit as claimed in claim 18, wherein:
the control circuit erases the learning procedure from the first region and the learning data from the second region, and
after the learning procedure stored in the first region and the learning data stored in the second region have been erased, the control circuit erases the setting data from the third region.

20. A protection method for a control chip, comprising:
storing a learning procedure and learning data to a memory;
in response to an access request pointing to the learning procedure:
determining whether the access request is provided from a specific circuit;
determining whether the access request is an instruction fetch request;
responsive to determining that the access request is provided from the specific circuit and the access request is an instruction fetch request, outputting the learning procedure to the specific circuit;
in response to the access request pointing to the learning data:
determining whether the access request is provided from the specific circuit,
decoding identification information to generate a decoded result, and
responsive to determining that the access request is provided from the specific circuit and the decoded result corresponds to the specific circuit, outputting the learning data to the specific circuit.
